(19) United States
(12) Patent Application Publication
(10) Pub. No.: US 2026/0135492 A1
(43) Pub. Date: May 14, 2026

(54) POWER CONVERTER

(71) Applicant: Silergy Semiconductor Technology (Hangzhou) LTD, Hangzhou (CN)

(72) Inventors: Gao Fan, Hangzhou (CN); Yunyu Zhao, Hangzhou (CN); Jinshuai Wang, Hangzhou (CN); Qiukai Huang, Hangzhou (CN)

(21) Appl. No.: 19/377,272

(22) Filed: Nov. 3, 2025

(30) Foreign Application Priority Data
Nov. 12, 2024 (CN) 202411612788.1

(51) Int. Cl. H02M 3/335

(52) U.S. Cl. CPC H02M 3/33592; H02M 3/33571

(57) ABSTRACT

A power converter can include: M transformer units, each including primary and secondary windings; M bridge arms, each being is coupled between two input terminals of the power converter to receive a DC input voltage, and each bridge arm comprises a high-side switch, a low-side switch, and a synchronous rectifier coupled in series; where a first terminal of each of the primary windings is coupled to a common node between the high-side switch and the low-side switch in one of the M bridge arms, and a second terminal of each primary winding is coupled together; and where one terminal of each of the secondary windings is coupled to a common node between the low-side switch and the synchronous rectifier in one of the M bridge arms, and the other terminal of each of the secondary windings is coupled to a first output terminal of the power converter.

### RELATED APPLICATIONS

This application claims the benefit of Chinese Patent Application No. 202411612788.1, filed on Nov. 12, 2024, which is incorporated herein by reference in its entirety.

### FIELD OF THE INVENTION

The present invention generally relates to the field of power electronics, and more particularly to power converters.

### BACKGROUND

A switched-mode power supply (SMPS), or a “switching” power supply, can include a power stage circuit and a control circuit. When there is an input voltage, the control circuit can consider internal parameters and external load changes, and may regulate the on/off times of the switch system in the power stage circuit. Switching power supplies have a wide variety of applications in modern electronics. For example, switching power supplies can be used to drive light-emitting diode (LED) loads.

### BRIEF DESCRIPTION OF THE DRAWINGS

FIGS. 1A and 1B are schematic diagrams of example power converters.

FIG. 2 is a schematic diagram of a first example power converter, in accordance with embodiments of the present invention.

FIGS. 3A and 3B are waveform diagrams of example operation of the first example power converter, in accordance with embodiments of the present invention.

FIG. 4 is a schematic diagram of a second example power converter, in accordance with embodiments of the present invention.

FIGS. 5A and 5B are waveform diagrams of example operation of the second example power converter, in accordance with embodiments of the present invention.

FIG. 6 is a schematic diagram of a third example power converter, in accordance with embodiments of the present invention.

FIG. 7 is a schematic diagram of a fourth example power converter, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. In addition, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

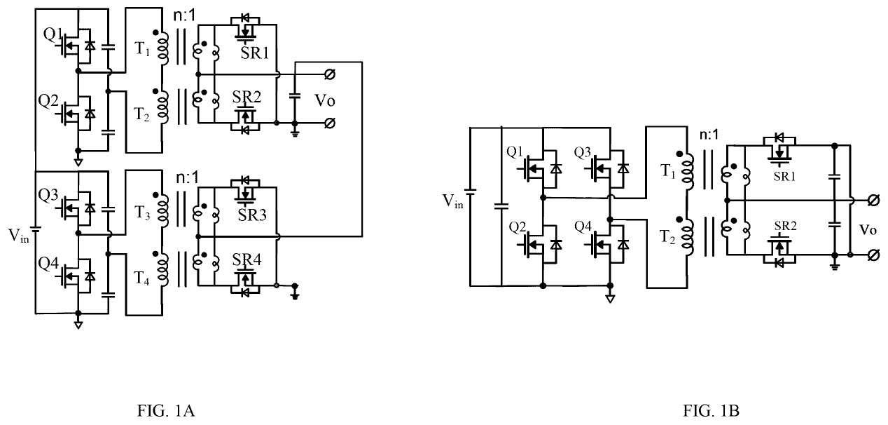

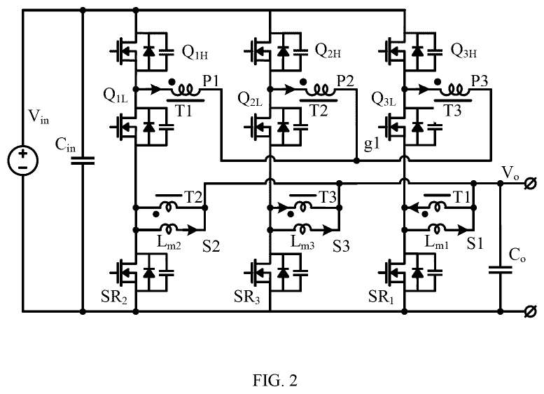

In order to achieve high system conversion efficiency, two-phase half-bridge current-doubler circuits and two-phase full-bridge current-doubler circuits are commonly used in some approaches for power conversion. In the two-phase half-bridge current-doubler circuit, as shown in FIG. 1A, power switches Q1, Q2, Q3, and Q4 are main power switches. When power switches Q1, Q2, Q3, and Q4 are turned on, the transformer is magnetized. When power switches Q1, Q2, Q3, and Q4 are turned off, the corresponding rectifier switches SR1-SR4 conduct to allow the magnetizing energy to freewheel for demagnetization. In this approach, since power switches Q1 and Q2 belong to the same half-bridge circuit, power switches Q1 and Q2 may not be turned on simultaneously; that is, the duty cycle range for the two-phase half-bridge circuit is 0-50%.

In the two-phase full-bridge current-doubler circuit as shown in FIG. 1B, power switches Q1 and Q3 are the main power switches. When power switches Q1 and Q3 are turned on, the transformer is magnetized. When power switches Q1 and Q3 are turned off, the corresponding rectifier switches SR1 and SR2 and the low-side switches (Q2, Q4) in the corresponding bridge arms conduct to perform demagnetization. In this approach, when the duty cycle is less than 50%, the output voltage is (D/N)*Vin, where D is the duty cycle and N is the transformer turns ratio. If the duty cycle exceeds 50%, a state can occur where the main power switches Q1 and Q3 are simultaneously turned on. In this state, the rectifier switches SR1 and SR2 are both off, so the magnetizing current freewheels through the body diodes, increasing losses and adversely affecting system efficiency. In addition, when the duty cycle is greater than 50%, the state where main power switches Q1 and Q3 are simultaneously in the on-state and the state where low-side switches Q2 and Q4 are simultaneously in the on-state are symmetrical. Consequently, when the duty cycle exceeds 50%, the output voltage of the circuit becomes [(1−D)/N]*Vin, preventing further adjustment of the voltage gain.

In particular embodiments, the power converter can include M transformer units and M bridge arms, where Mis an integer and M≥3. Each transformer unit can include a primary winding and a secondary winding. Each bridge arm can be coupled between the two input terminals of the power converter to receive DC input voltage Vin. Each bridge arm can also include a high-side switch, a low-side switch, and a synchronous rectifier connected in series. Also in particular embodiments, the dotted terminal of each primary winding can connect to the common node between the high-side switch and the low-side switch in one of the M bridge arms. The non-dotted terminals of all primary windings can connect to the same first common node. One terminal of each secondary winding can connect to the common node between the low-side switch and the synchronous rectifier in one of the M bridge arms. The other terminal of each secondary winding can connect to the same second common node, and the second common node can connect to the first output terminal of the power converter, where output voltage Vo is generated at the first output terminal. The second output terminal of the power converter can be grounded.

In one embodiment, each bridge arm can be coupled to one primary winding and one secondary windings in different transformer units. That is, each of the bridge arms can be coupled to the primary winding in one of the M transformer units, and to the secondary winding in another one of the M transformer units. In another example, each bridge arm can be coupled to one primary winding and one secondary winding in the same transformer unit. That is, each of the bridge arms can be coupled to the primary winding in one of the M transformer units, and to the secondary winding in the one of the M transformer units.

Referring now to FIG. 2, shown is a schematic diagram of a first example power converter, in accordance with embodiments of the present invention. In this particular example, the power converter can include 3 transformer units and 3 bridge arms; however, any suitable number and structure of the transformer units and bridge arms can be supported in certain embodiments. In particular embodiments, transformer unit T1 can include primary winding P1 and secondary winding S1, transformer unit T2 can include primary winding P2 and secondary winding S2, and transformer unit T3 can include primary winding P3 and secondary winding S3. Each bridge arm can be coupled to one primary winding and one secondary winding in different transformer units. The first bridge arm can include high-side switch Q_{1H}, low-side switch Q_{1L}, and synchronous rectifier SR₂ connected in series, the second bridge arm can include high-side switch Q_{2H}, low-side switch Q_{2L}, and synchronous rectifier SR₃ connected in series, and the third bridge arm can include high-side switch Q_{3H}, low-side switch Q_{3L}, and synchronous rectifier SR₁ connected in series.

The power converter can also include first inductors Lₘ₁, Lₘ₂, and Lₘ₃ connected in parallel with secondary windings S1, S2, and S3, respectively. First inductors Lₘ₁, Lₘ₂, and Lₘ₃ can be implemented by the magnetizing inductance of each transformer unit, or by externally connected discrete inductors. In practical transformers, due to non-ideal core and windings, numerous parasitic parameters exist. Firstly, the permeability of the core is not infinite, so the secondary winding of a transformer can be equivalent to an ideal secondary winding in parallel with a magnetizing inductance. Secondly, the primary and secondary windings are not perfectly coupled, and some leakage inductance exists, but this is substantially neglected here. Transformer units T1, T2, and T3 can be three separate transformer modules, or may be integrated into a single transformer module using magnetic integration.

In addition, the dotted terminal of primary winding P1 of transformer unit T1 can connect to the common node between high-side switch Q_{1H} and low-side switch Q_{1L} in the first bridge arm, and the dotted terminal of secondary winding S1 of transformer unit T1 can connect to the common node between low-side switch Q_{3L} and synchronous rectifier SR₁ in the third bridge arm. The dotted terminal of primary winding P2 of transformer unit T2 can connect to the common node between high-side switch Q_{2H} and low-side switch Q21, in the second bridge arm, and the dotted terminal of secondary winding S2 of transformer unit T2 can connect to the common node between low-side switch Q1 and synchronous rectifier SR₂ in the first bridge arm. The dotted terminal of primary winding P3 of transformer unit T3 can connect to the common node between high-side switch Q_{3H} and low-side switch Q_{3L} in the third bridge arm, and the dotted terminal of secondary winding S3 of transformer unit T3 can connect to the common node between low-side switch Q21, and synchronous rectifier SR₃ in the second bridge arm. All non-dotted terminals of the primary windings can connect to common node g1. All non-dotted terminals of the secondary windings can connect to output capacitor Co.

In the power converter shown in FIG. 2, high-side switches Q_{1H}, Q_{2H}, and Q_{3H} in each bridge arm are the main power switches. That is, during operation, the ratio of the conduction time of each of high-side switches Q_{1H}, Q_{2H}, and Q_{3H} to the switching period can be defined as duty cycle D. The duty cycle D and the conduction time may be the same for all high-side switches Q_{1H}, Q_{2H}, and Q_{3H}. In particular embodiments, the control signals for high-side switches Q_{1H}, Q_{2H}, and Q_{3H} may have a sequential phase difference of 120°.

In addition, synchronous rectifiers SR₁, SR₂, and SR₃ can be driven complementarily to their corresponding main power switches Q_{1H}, Q_{2H}, and Q_{3H}, respectively, e.g., satisfying Vg_SR₁=!Vg_Q_{1H}, Vg_SR₂=!Vg_Q_{2H}, Vg_SR₃=!Vg_Q_{3H}. As used herein, “!” means an inverted version thereof. Here, complementary conduction is based on ideal conditions whereby the related power switches do not conduct simultaneously, without considering dead time. When dead time exists, synchronous rectifiers SR₁, SR₂, and SR₃ and their corresponding main power switches Q_{1H}, Q_{2H}, and Q_{3H} can conduct non-overlappingly. Here, Vg_SRᵢ, Vg_Q_{iH}, Vg_Q_{iL} are the control signals for the corresponding synchronous rectifier, high-side switch, and low-side switch, respectively.

Moreover, the low-side switch Q_{1L}, Q_{2L}, Q_{3L} in each bridge arm can connect when all other power switches in its corresponding bridge arm are turned off, e.g., satisfying “Vg_Q_{1L}=!Vg_Q_{1H}&!Vg_SR₂”, “Vg_Q_{2L}=!Vg_Q_{2H}&!Vg_SR₃”, Vg_Q_{3L}=!Vg_Q_{3H} &!Vg_SR₁”. That is, low-side switch Q_{1L} can conduct when both high-side switch Q_{1H} and synchronous rectifier SR₂ are off, low-side switch Q_{2L} can connect when both high-side switch Q_{2H} and synchronous rectifier SR₃ are off, and low-side switch Q_{3L} can conduct when both high-side switch Q_{3H} and synchronous rectifier SR₁ are off.

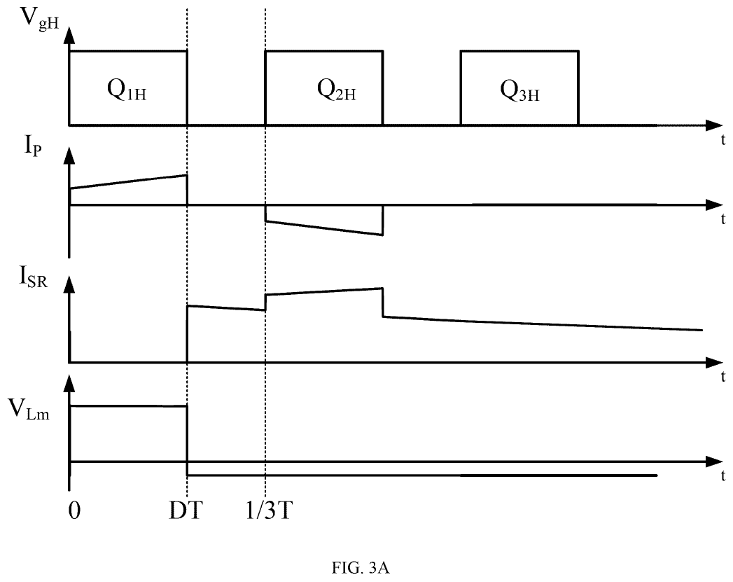

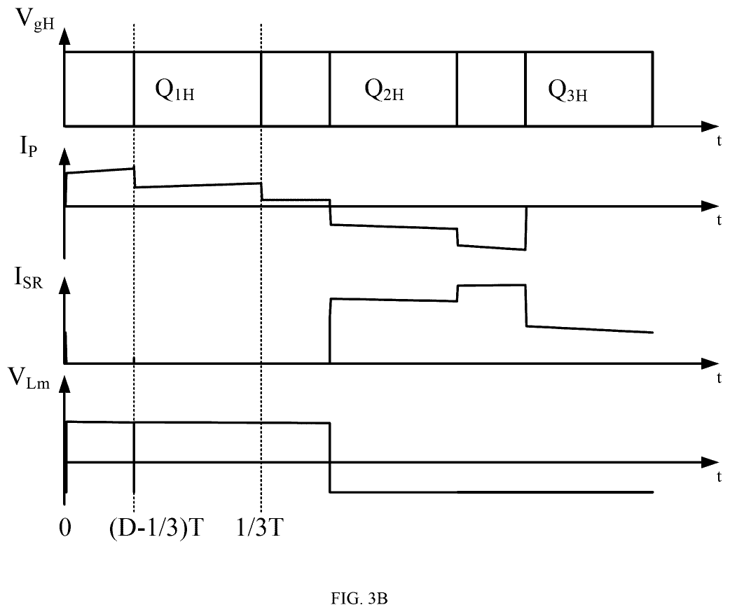

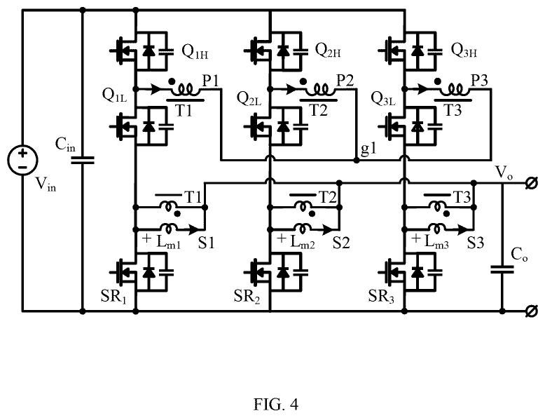

Referring now to FIGS. 3A and 3B, shown are waveform diagrams of example operation of the first example power converter, in accordance with embodiments of the present invention. FIG. 3A mainly shows the operating waveforms of transformer unit T1 under the condition where duty cycle D is less than 1/3. FIG. 3B mainly shows the operating waveforms of transformer unit T1 under the condition where duty cycle D is greater than 1/3 and less than 2/3. For clarity and brevity, only the first one-third of each operating period T is analyzed here. Ip represents the current flowing through the primary winding of the transformer unit, I_{SR} represents the current flowing through the synchronous rectifier, and V_{Lm} represents the voltage across the first inductor connected in parallel with the secondary winding.

Analysis for D<1/3: First, consider the case where duty cycle D is less than 1/3. Referring to FIG. 3A and FIG. 2, during the time interval 0 to DT, high-side switch Q_{1H} is turned on, high-side switches Q_{2H} and Q_{3H} are off, and synchronous rectifiers SR₂ and SR₃ are turned on. The current path is: high-side switch Q_{1H}→primary winding P1 of T1→primary winding P3 of T3→output capacitor Co.

Thus (e.g., defining the dotted terminal as positive terminal):

$${V}_{i n} = {V}_{P 1} - {V}_{P 3} + {V}_{S 1} + {V}_{o}$$

And, secondary windings S2 and S3 are in parallel with output capacitor Co, so:

$${V}_{Lm 2} = {V}_{Lm 3} = {V}_{S 2} = {V}_{S 3} = - {V}_{o}$$

Here, V_{Si} is the voltage across the i-th secondary winding. Defining the turns ratio of the transformer as Np:Ns, according to the transformer definition:

$$\frac{{V}_{P 1}}{{V}_{S 1}} = \frac{{V}_{P 2}}{{V}_{S 2}} = \frac{{V}_{P 3}}{{V}_{S 3}} = \frac{{N}_{P}}{{N}_{S}}$$

Rearranging the equation, substituting gives:

$${V}_{i n} = {V}_{P 1} - {V}_{P 3} + {V}_{S 1} + {V}_{o} = ( \frac{{N}_{p}}{{N}_{s}} + 1 ) {V}_{S 1} - ( {V}_{S 3} \cdot \frac{{N}_{p}}{{N}_{s}} ) + {V}_{o} = ( \frac{{N}_{p}}{{N}_{s}} + 1 ) {V}_{L m 1} - ( - {V}_{o} \cdot \frac{{N}_{p}}{{N}_{s}} ) + {V}_{o} = \frac{{N}_{p} + {N}_{s}}{{N}_{s}} {V}_{L m 1} + \frac{{N}_{p} + {N}_{s}}{{N}_{s}} {V}_{o}$$

Then, it can be deduced that:

$${V}_{L m 1} = \frac{{N}_{s}}{{N}_{p} + {N}_{s}} {V}_{i n} - {V}_{o}$$

During the time interval DT to T/3: high-side switches Q_{1H}, Q_{2H} and Q_{3H} are all turned off, and synchronous rectifiers SR₁, SR₂ and SR₃ are all turned on. Therefore:

$${V}_{L m 1} = {V}_{L m 2} = {V}_{L m 3} = - {V}_{o}$$

Consequently:

$${V}_{L m 1} = \{ \begin{matrix}\frac{{N}_{s}}{{N}_{p} + {N}_{s}} {V}_{i n} - {V}_{o} & ( 0 \sim DT ) \\ - {V}_{o} & ( DT \sim T )\end{matrix}$$

The voltages of first inductors Lm2 and lm3 can be obtained in a similar way, respectively. Under steady state, applying the inductor volt-second balance principle using the above formulas:

$$DT \cdot ( \frac{{N}_{s}}{{N}_{p} + {N}_{s}} {V}_{i n} - {V}_{o} ) - ( T - DT ) \cdot {V}_{o} = 0$$

Then, it can be deduced that:

$${V}_{o} = D \cdot \frac{{N}_{s}}{{N}_{p} + {N}_{s}} {V}_{i n}$$

Analysis for 1/3<D<2/3: Now consider the case where duty cycle D is greater than 1/3 and less than 2/3. Referring to FIG. 3B and FIG. 2, during the time interval 0 to (D−1/3) T, high-side switches Q_{1H} and Q_{3H} are turned on, high-side switch Q_{2H} is turned off, low-side switch Q_{2L} is turned on, and synchronous rectifier SR₂ is turned on.

Thus:

$${V}_{i n} = {V}_{P 1} - {V}_{P 2} + {V}_{S 3} + {V}_{o}$$

$${V}_{i n} = {V}_{P 3} - {V}_{P 2} + {V}_{S 3} + {V}_{o}$$

$${V}_{P 1} = {V}_{P 3}$$

Secondary winding S2 is in parallel with output capacitor Co, so:

$${V}_{L m 2} = {V}_{S 2} = - {V}_{o}$$

According to the transformer definition, it can be deduced that:

$${V}_{i n} = {V}_{P 3} + {V}_{S 3} - {V}_{P 2} + {V}_{o} = ( \frac{{N}_{p}}{{N}_{s}} + 1 ) {V}_{S 3} - ( {V}_{S 2} \cdot \frac{{N}_{p}}{{N}_{s}} ) + {V}_{o} = ( \frac{{N}_{p}}{{N}_{s}} + 1 ) {V}_{L m 3} - ( - {V}_{o} \cdot \frac{{N}_{p}}{{N}_{s}} ) + {V}_{o} = \frac{{N}_{p} + {N}_{s}}{{N}_{s}} {V}_{L m 3} + \frac{{N}_{p} + {N}_{s}}{{N}_{s}} {V}_{o}$$

Then, it can be deduced that:

$${V}_{L m 1} = \frac{{N}_{s}}{{N}_{p} + {N}_{s}} {V}_{i n} - {V}_{o}$$

During the time interval (D−1/3) T to T/3: high-side switch Q_{1H} is turned on, high-side switches Q_{2H} and Q_{3H} are turned off, and synchronous rectifiers SR₂ and SR₃ are turned on. The current path is: high-side switch Q_{1H}→primary winding P1 of transformer T1→primary winding P3 of transformer T3→output capacitor Co. Therefore:

$${V}_{L m 1} = \frac{{N}_{s}}{{N}_{p} + {N}_{s}} {V}_{i n} - {V}_{o}$$

$${V}_{L m 2} = {V}_{L m 3} = - {V}_{o}$$

Consequently:

$${V}_{L m 1} = \{ \begin{matrix}\frac{{N}_{s}}{{N}_{p} + {N}_{s}} {V}_{i n} - {V}_{o} & ( 0 \sim DT ) \\ - {V}_{o} & ( DT \sim T )\end{matrix}$$

The voltages of first inductors Lm2 and lm3 can be obtained in a similar way, respectively. Under steady state, applying the inductor volt-second balance principle using the above

$${V}_{o} = D \cdot \frac{{N}_{s}}{{N}_{p} + {N}_{s}} {V}_{i n}$$

It can be concluded that the power converter according to particular embodiments, through its circuit structure adjustment, output voltage Vo can be equal to

$$D \cdot \frac{{N}_{s}}{{N}_{p} + {N}_{s}} {V}_{i n} ,$$

and output voltage Vo in conventional approaches can be equal to

$$D \cdot \frac{{N}_{s}}{{N}_{p}} {V}_{i n} .$$

Consequently, for the same output voltage condition, the number of turns for the transformer primary winding can be reduced in certain embodiments, thereby decreasing transformer losses and cost.

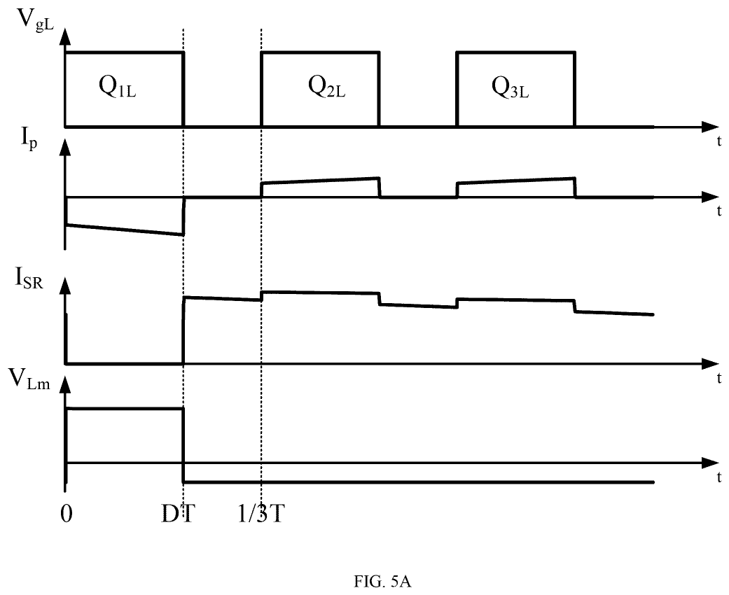

Referring now to FIG. 4, shown is a schematic diagram of a second example power converter, in accordance with embodiments of the present invention. In this particular example, the power converter includes 3 transformer units and 3 bridge arms, and here each bridge arm is coupled only to one primary winding and one secondary winding in the same transformer unit. In particular embodiments, transformer unit T1 can include primary winding P1 and secondary winding S1, transformer unit T2 can include primary winding P2 and secondary winding S2, and transformer unit T3 can include primary winding P3 and secondary winding S3. Each bridge arm is coupled to the primary and secondary windings in the same transformer unit. The first bridge arm can include high-side switch Q_{1H}, low-side switch Q_{1L}, and synchronous rectifier SR₁ connected in series, the second bridge arm can include high-side switch Q_{2H}, low-side switch Q_{2L}, and synchronous rectifier SR₂ connected in series, and the third bridge arm can include high-side switch Q_{3H}, low-side switch Q_{3L}, and synchronous rectifier SR₃ connected in series.

In addition, the dotted terminal of primary winding P1 of transformer unit T1 can connect to the common node between high-side switch Q_{1H} and low-side switch Q_{1L} in the first bridge arm, and the non-dotted terminal of secondary winding S1 of transformer unit T1 can connect to the common node between low-side switch Q_{1L} and synchronous rectifier SR₁ in the first bridge arm. The dotted terminal of primary winding P2 of transformer unit T2 can connect to the common node between high-side switch Q_{2H} and low-side switch Q_{2L} in the second bridge arm, and the non-dotted terminal of secondary winding S2 of transformer unit T2 can connect to the common node between low-side switch Q_{2L} and synchronous rectifier SR₂ in the second bridge arm. The dotted terminal of primary winding P3 of transformer unit T3 can connect to the common node between high-side switch Q_{3H} and low-side switch Q_{3L} in the third bridge arm, and the non-dotted terminal of secondary winding S3 of transformer unit T3 can connect to the common node between low-side switch Q_{3L} and synchronous rectifier SR₃ in the third bridge arm. All non-dotted terminals of the primary windings can connect to a common node g1. All dotted terminals of the secondary windings can connect to output capacitor Co.

In the power converter shown in FIG. 4, low-side switches Q_{1L}, Q_{2L}, and Q_{3L} in each bridge arm are the main power switches. That is, during operation, the ratio of the conduction time of each of low-side switches Q_{1L}, Q_{2L}, and Q_{3L} to the switching period is defined as duty cycle D. The duty cycle D and the conduction time are the same for all low-side switches Q_{1L}, Q_{2L}, and Q_{3L}. In particular embodiments, the control signals for low-side switches Q_{1L}, Q_{2L}, and Q_{3L} may have a sequential phase difference of 120°.

In addition, synchronous rectifiers SR₁, SR₂, and SR₃ are turned on complementarily to their corresponding main power switches Q_{1L}, Q_{2L}, and Q_{3L}, respectively; that is, satisfying Vg_SR₁=!Vg_Q_{1L}, Vg_SR₂=!Vg_Q_{2L}, and Vg_SR₃=!Vg_Q_{3L}. It should be noted that the complementary conduction mentioned here is based on ideal conditions where the related power switches do not conduct simultaneously, without considering dead time. When dead time exists, synchronous rectifiers SR₁, SR₂, and SR₃ and their corresponding main power switches Q_{1L}, Q_{2L}, and Q_{3L} conduct non-overlappingly. Moreover, high-side switches Q_{1H}, Q_{2H}, Q_{3H} in each bridge arm are turned on complementarily to their corresponding main power switches Q_{1L}, Q_{2L}, and Q_{3L}, respectively. That is, satisfying Vg_Q_{1H}=!Vg_Q_{1L}, Vg_Q_{2H}=!Vg_Q_{2L}, and Vg_Q_{3H}=!Vg_Q_{3L}.

From the above, it can be understood that, on one hand, regarding the circuit structure, the solution of the first example involves an interleaving of the primary and secondary windings of the transformers, one bridge arm needs to connect to two different transformers. In contrast, in the solution of the second example, one transformer is associated with only one bridge arm, making the circuit implementation simpler. On the other hand, regarding the control method, in the solution of the first example, the low-side switch of each bridge arm conducts when all other power switches on its corresponding bridge arm are turned off, requiring a relatively complex control method for each low-side switch, involving independent judgment and control. In the solution of the second example, the control logic for the high-side switches is the same as that for synchronous rectifiers SR. This may eliminate the need for additional logic judgment, can reduce the number of corresponding control signals, and may lower the requirements for the control circuit.

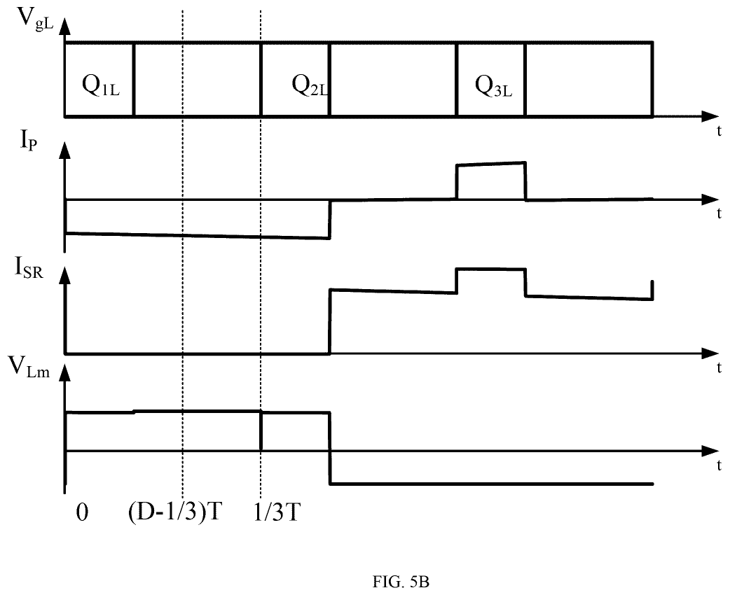

Referring now to FIGS. 5A and 5B, shown are waveform diagrams of example operation of the second example power converter, in accordance with embodiments of the present invention. FIG. 5A mainly shows the operating waveforms of transformer unit T1 under the condition where duty cycle D is less than 1/3. FIG. 5B mainly shows the operating waveforms of transformer unit T1 under the condition where duty cycle D is greater than 1/3 and less than 2/3. For clarity and brevity, only the first one-third of each operating period T is analyzed here. Ip represents the current flowing through the primary winding of the transformer unit, I_{SR} represents the current flowing through the synchronous rectifier, and V_{Lm} represents the voltage across the first inductor connected in parallel with the secondary winding.

Analysis for D<1/3: First, consider the case where duty cycle D is less than 1/3. Referring to FIG. 5A and FIG. 4, during the time interval 0 to DT, low-side switch Q_{1L} is turned on, low-side switches Q_{2L} and Q_{3L} are turned off. Thus (e.g., the dotted terminal of the transformer is defined as positive terminal, and the positive terminal of the inductor is opposite to the positive terminal of the transformer):

$${V}_{i n} = {V}_{P 2} - {V}_{P 1} - {V}_{S 1} + {V}_{o}$$

$${V}_{i n} = {V}_{P 3} - {V}_{P 1} - {V}_{S 1} + {V}_{o}$$

At the same time, synchronous rectifiers SR₂ and SR₃ are turned on. Secondary windings S2 and S3 are in parallel with output capacitor Co, so:

$${V}_{S 2} = {V}_{S 3} = {V}_{o}$$

$${V}_{L m 2} = {V}_{L m 3} = - {V}_{o}$$

According to the transformer definition (turns ratio is Np:Ns), it can be deduced that:

$${V}_{i n} = \frac{{N}_{p}}{{N}_{s}} {V}_{S 2} - ( \frac{{N}_{p}}{{N}_{s}} + 1 ) {V}_{S 1} + {V}_{o} = \frac{{N}_{p} + {N}_{s}}{{N}_{s}} {V}_{L m 1} + \frac{{N}_{p} + {N}_{s}}{{N}_{s}} {V}_{o}$$

Rearranging the equation, substituting gives:

$${V}_{L m 1} = \frac{{N}_{s}}{{N}_{p} + {N}_{s}} {V}_{i n} - {V}_{o}$$

During the time interval DT to T/3, synchronous rectifiers SR₁, SR₂ and SR₃ are all turned on. Therefore:

$${V}_{L m 1} = {V}_{L m 2} = {V}_{L m 3} = - {V}_{o}$$

Under steady state, applying the inductor volt-second balance principle using the above formulas yields, it can be deduced that:

$${V}_{o} = D \cdot \frac{{N}_{s}}{{N}_{p} + {N}_{s}} {V}_{i n}$$

Analysis for 1/3<D<2/3: Now consider the case where the duty cycle D is greater than 1/3 and less than 2/3. Referring to FIG. 5B and FIG. 4, during the time interval 0 to (D−1/3)T, low-side switches Q_{1L} and Q_{3L} are turned on, low-side switch Q_{2L} is turned off, and synchronous rectifier SR₂ is turned on. Thus (e.g., the dotted terminal of the transformer is defined as positive terminal, and the positive terminal of the inductor is opposite to the positive terminal of the transformer):

$${V}_{i n} = {V}_{P 2} - {V}_{P 1} - {V}_{S 1} + {V}_{o}$$

$${V}_{i n} = {V}_{P 2} - {V}_{P 3} - {V}_{S 3} + {V}_{o}$$

Synchronous rectifier SR₂ is turned on, causing secondary winding S2 to be in parallel with output capacitor Co, so:

$${V}_{S 2} = {V}_{o} , \qquad {V}_{L m 2} = - {V}_{o}$$

According to the transformer definition, it can be deduced that:

$${V}_{i n} = \frac{{N}_{p}}{{N}_{s}} {V}_{S 2} - ( \frac{{N}_{p}}{{N}_{s}} + 1 ) {V}_{S 1} + {V}_{o} = \frac{{N}_{p} + {N}_{s}}{{N}_{s}} {V}_{L m 1} + \frac{{N}_{p} + {N}_{s}}{{N}_{s}} {V}_{o}$$

Rearranging the equation, substituting gives:

$${V}_{L m 1} = \frac{{N}_{s}}{{N}_{p} + {N}_{s}} {V}_{i n} - {V}_{o}$$

Similarly:

$${V}_{L m 3} = \frac{{N}_{s}}{{N}_{p} + {N}_{s}} {V}_{i n} - {V}_{o}$$

During the time interval (D−1/3)T to T/3, low-side switch Q_{1L} is turned on, synchronous rectifiers SR₂ and SR₃ are turned on, and secondary windings S2 and S3 are in parallel with output capacitor Co, so:

$${V}_{L m 1} = \frac{{N}_{s}}{{N}_{p} + {N}_{s}} {V}_{i n} - {V}_{o}$$

$${V}_{L m 2} = {V}_{L m 3} = - {V}_{o}$$

Under steady state, applying the inductor volt-second balance principle using the above formulas yields, it can be deduced that:

$${V}_{o} = D \cdot \frac{{N}_{s}}{{N}_{p} + {N}_{s}} {V}_{i n}$$

It can thus be concluded that the power converter according to particular embodiments, through its circuit structure adjustment, output voltage Vo can be equal to

$$D \cdot \frac{{N}_{s}}{{N}_{p} + {N}_{s}} {V}_{i n} ,$$

and output voltage Vo in conventional approaches may be equal to

$$D \cdot \frac{{N}_{s}}{{N}_{p} + {N}_{s}} {V}_{i n} .$$

Consequently, for the same output voltage condition, the number of turns for the primary winding of the transformer can be reduced, thereby decreasing transformer losses and cost.

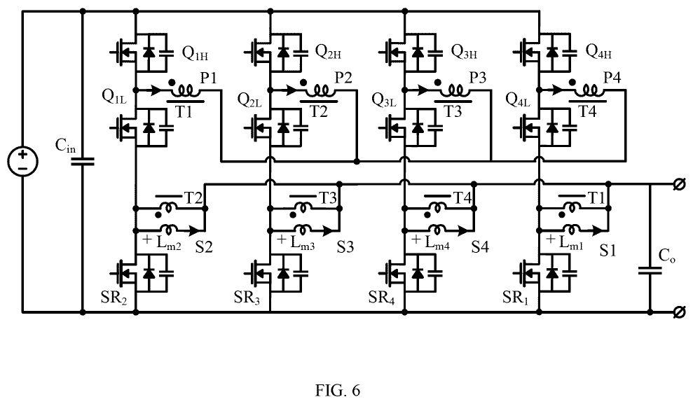

Referring now to FIG. 6, shown is a schematic diagram of a third example power converter, in accordance with embodiments of the present invention. In this particular example, the power converter can include 4 transformer units and 4 bridge arms. In certain embodiments, transformer unit T1 can include primary winding P1 and secondary winding S1, transformer unit T2 can include primary winding P2 and secondary winding S2, transformer unit T3 can include primary winding P3 and secondary winding S3, and transformer unit T4 can include primary winding P4 and secondary winding S4. Each bridge arm can be coupled to one primary winding and one secondary winding in different transformer units. The first bridge arm can include high-side switch Q_{1H}, low-side switch Q_{1L}, and synchronous rectifier SR₂ connected in series, the second bridge arm can include high-side switch Q_{2H}, low-side switch Q_{2L}, and synchronous rectifier SR₃ connected in series, the third bridge arm can include high-side switch Q_{3H}, low-side switch Q_{3L}, and synchronous rectifier SR₄ connected in series, and the fourth bridge arm can include high-side switch Q_{4H}, low-side switch Q_{4L}, and synchronous rectifier SR₁ connected in series.

In addition, the dotted terminal of primary winding P1 of transformer unit T1 can connect to the common node between high-side switch Q_{1H} and low-side switch Q_{1L} in the first bridge arm, and the dotted terminal of secondary winding S1 of transformer unit T1 can connect to the common node between low-side switch Q_{4L} and synchronous rectifier SR₁ in the fourth bridge arm. The dotted terminal of primary winding P2 of transformer unit T2 can connect to the common node between high-side switch Q_{2H} and low-side switch Q_{2L} in the second bridge arm, and the dotted terminal of secondary winding S2 of transformer unit T2 can connect to the common node between low-side switch Qu, and synchronous rectifier SR₂ in the first bridge arm. The dotted terminal of primary winding P3 of transformer unit T3 can connect to the common node between high-side switch Q_{3H} and low-side switch Q31, in the third bridge arm, and the dotted terminal of secondary winding S3 of transformer unit T3 can connect to the common node between low-side switch Q21, and synchronous rectifier SR₃ in the second bridge arm. The dotted terminal of primary winding P4 of transformer unit T4 can connect to the common node between high-side switch Q_{4H} and low-side switch Q41, in the fourth bridge arm, and the dotted terminal of secondary winding S4 of transformer unit T4 can connect to the common node between low-side switch Q31, and synchronous rectifier SR₄ in the third bridge arm. All non-dotted terminals of the primary windings can connect to common node g1. All non-dotted terminals of the secondary windings can connect to output capacitor Co.

In the power converter shown in FIG. 6, high-side switches Q_{1H}, Q_{2H}, Q_{3H}, and Q_{4H} in each bridge arm are the main power switches. That is, during operation, the ratio of the conduction time of each of high-side switches Q_{1H}, Q_{2H}, Q_{3H}, and Q_{4H} to the switching period is defined as duty cycle D. The duty cycle D and the conduction time are the same for all high-side switches Q_{1H}, Q_{2H}, Q_{3H}, and Q_{4H}. In particular embodiments, the control signals for high-side switches Q_{1H}, Q_{2H}, Q_{3H}, and Q_{4H} may have a sequential phase difference of 90°.

In addition, synchronous rectifiers SR₁, SR₂, SR₃, and SR₄ can be driven complementarily to their corresponding main power switches Q_{1H}, Q_{2H}, Q_{3H}, and Q_{4H}, respectively; that is, satisfying Vg_SR₁=!Vg_Q_{1H}, Vg_SR₂=!Vg_Q_{2H}, Vg_SR₃=!Vg_Q_{3H}, and Vg_SR₄=!Vg_Q_{4H}. Moreover, low-side switches Q_{1L}, Q_{2L}, Q_{3L}, and Q_{4L}, in each bridge arm conduct when all other power switches on their corresponding bridge arm are turned off; that is, satisfying Vg_Q_{1L}=!Vg_Q_{1H}&!Vg_SR₂, Vg_Q_{2L}=!Vg_Q_{2H} &!Vg_SR₃, Vg_Q_{3L}=!Vg_Q_{3H} &!Vg_SR₄, and Vg_Q_{4L}=!Vg_Q_{4H}&!Vg_SR₁, e.g., low-side switch Q_{1L} can conduct when both high-side switch Q_{1H} and synchronous rectifier SR₂ are turned off, low-side switch Q_{2L} conducts when both high-side switch Q_{2H} and synchronous rectifier SR₃ are turned off, low-side switch Q_{3L} can conduct when both high-side switch Q_{3H} and synchronous rectifier SR₄ are turned off, and low-side switch Q_{4L} can conduct when both high-side switch Q_{4H} and synchronous rectifier SR₁ are turned off.

Based on the first and third examples above, the structure and operating states of the power converter including M bridge arms and M transformer units can be deduced. In particular embodiments, i-th bridge arm can include i-th high-side switch, i-th low-side switch, and (i+1)-th synchronous rectifier connected in series. I-th transformer unit can include i-th primary winding and i-th secondary winding. The dotted terminal of the i-th primary winding can connect to the common node between the i-th high-side switch and the i-th low-side switch, and the dotted terminal of the (i+1)-th secondary winding can connect to the common node between the (i+1)-th synchronous rectifier and the i-th low-side switch, where i is an integer that is less than M.

In particular embodiments, i-th bridge arm can include i-th high-side switch, i-th low-side switch, and first synchronous rectifier connected in series. The dotted terminal of the i-th primary winding can connect to the common node between the i-th high-side switch and the i-th low-side switch, and the dotted terminal of the first secondary winding can connect to the common node between the first synchronous rectifier and the i-th low-side switch, where i is equal to M. Each high-side switch serves as the main power switch. Conduction times of high-side switches are the same, and sequentially have a phase difference of 360°/M. The i-th synchronous rectifier is driven complementarily to the i-th high-side switch. Each low-side switch conducts when both the high-side switch and the synchronous rectifier on its bridge arm are turned off.

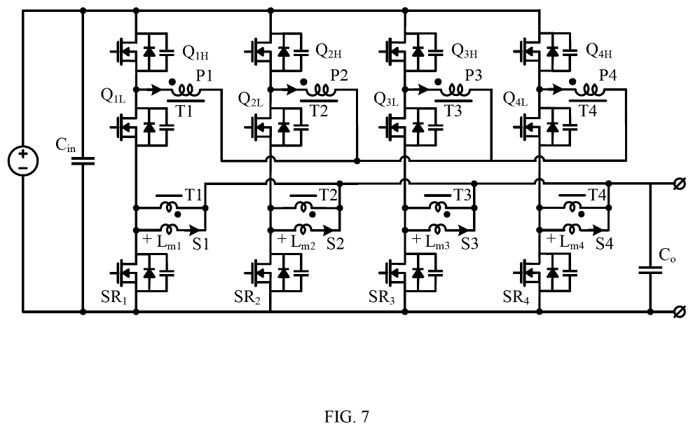

Referring now to FIG. 7, shown is a schematic diagram of a fourth example power converter, in accordance with embodiments of the present invention. This particular example illustrates the power converter using an example including 4 transformer units and 4 bridge arms. In certain embodiments, transformer unit T1 can include primary winding P1 and secondary winding S1, transformer unit T2 can include primary winding P2 and secondary winding S2, transformer unit T3 can include primary winding P3 and secondary winding S3, and transformer unit T4 can include primary winding P4 and secondary winding $4. Each bridge arm can be coupled to one primary winding and one secondary winding in the same transformer unit. The first bridge arm can include high-side switch Q_{1H}, low-side switch Q_{1L}, and synchronous rectifier SR₁ connected in series, the second bridge arm can include high-side switch Q_{2H}, low-side switch Q_{2L}, and synchronous rectifier SR₂ connected in series, the third bridge arm can include high-side switch Q_{3H}, low-side switch Q_{3L}, and synchronous rectifier SR₃ connected in series, and the fourth bridge arm can include high-side switch Q_{4H}, low-side switch Q_{4L}, and synchronous rectifier SR₄ connected in series.

In addition, the dotted terminal of primary winding P1 of transformer unit T1 can connect to the common node between high-side switch Q_{1H} and low-side switch Qu, in the first bridge arm, and the non-dotted terminal of secondary winding S1 of transformer unit T1 can connect to the common node between low-side switch Qu, and synchronous rectifier SR₁ in the first bridge arm. The dotted terminal of the primary winding P2 of transformer unit T2 can connect to the common node between high-side switch Q_{2H} and low-side switch Q_{2L} in the second bridge arm, and the non-dotted terminal of secondary winding S2 of transformer unit T2 can connect to the common node between low-side switch Q21, and synchronous rectifier SR₂ in the second bridge arm. The dotted terminal of primary winding P3 of transformer unit T3 can connect to the common node between high-side switch Q_{3H} and low-side switch Q_{3L} in the third bridge arm, and the non-dotted terminal of secondary winding S3 of transformer unit T3 can connect to the common node between low-side switch Q_{3L} and synchronous rectifier SR₃ in the third bridge arm. The dotted terminal of primary winding P4 of transformer unit T4 can connect to the common node between high-side switch Q_{4H} and low-side switch Q_{4L} in the fourth bridge arm, and the non-dotted terminal of secondary winding S4 of transformer unit T4 can connect to the common node between low-side switch Q_{4L} and synchronous rectifier SR₄ in the fourth bridge arm. All non-dotted terminals of the primary windings can connect to common node g1. All dotted terminals of the secondary windings can connect to output capacitor Co.

In the power converter shown in FIG. 7, low-side switches Q_{1L}, Q_{2L}, Q_{3L}, and Q_{4L} in each bridge arm are the main power switches. That is, during operation, the ratio of the conduction time of each of low-side switches Q_{1L}, Q_{2L}, Q_{3L}, and Q_{4L} to the switching period is defined as duty cycle D. The duty cycle D and the conduction time can be the same for all low-side switches Q_{1L}, Q_{2L}, Q_{3L}, and Q_{4L}. In particular embodiments, the control signals for low-side switches Q_{1L}, Q_{2L}, Q_{3L}, and Q_{4L} may have a sequential phase difference of 90°.

In addition, synchronous rectifiers SR₁, SR₂, SR₃, SR₄ are driven complementarily to their corresponding main power switches Q_{1L}, Q_{2L}, Q_{3L}, and Q_{4L}, respectively; that is., satisfying Vg_SR₁=!Vg_Q_{1L}, Vg_SR₂=!Vg_Q_{2L}, Vg_SR₃=!Vg_Q_{3L}, and Vg_SR₄=!Vg_Q_{4L}. Moreover, high-side switches Q_{1H}, Q_{2H}, Q_{3H}, and Q_{4H} in each bridge arm are also driven complementarily to their corresponding main power switches Q_{1L}, Q_{2L}, Q_{3L}, and Q_{4L}, respectively; that is, satisfying Vg_Q_{1H}=!Vg_Q_{1L}, Vg_Q_{2H}=!Vg_Q_{2L}, Vg_Q_{3H}=!Vg_Q_{3L}, and Vg_Q_{4H}=!Vg_Q_{4L}.

Based on the second and fourth converter examples above, the structure and operating states of the power converter including M bridge arms and M transformer units can be deduced. In particular embodiments, the i-th bridge arm can include i-th high-side switch, i-th low-side switch and i-th synchronous rectifier connected in series. I-th transformer unit can include i-th primary winding and i-th secondary winding. The dotted terminal of the i-th primary winding can connect to the common node between the i-th high-side switch and the i-th low-side switch, and the non-dotted terminal of the i-th secondary winding can connect to the common node between the i-th low-side switch and the i-th synchronous rectifier, where i is an integer number not greater than M.

Each low-side switch may serve as the main power switch. Conduction times of low-side switches may be the same, and sequentially have a phase difference of 360°/M. The i-th synchronous rectifier can be driven complementarily to the i-th low-side switch, and the i-th high-side switch is driven complementarily to the i-th low-side switch. From the above, it can be understood that the power converter of particular embodiments is a magnetically integrated current-doubler rectification circuit with a low transformer turns ratio. By adjusting the connection method between the synchronous rectifiers and its corresponding bridge arms, the power converter can both increase the effective duty cycle of the system and reduce the circuit gain. Consequently, for the same output voltage, the power converter of particular embodiments can utilize a transformer with lower turns ratio, thereby reducing transformer losses and lowering the cost of the transformer.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. A power converter, comprising:
a) M transformer units, wherein each transformer unit comprises a primary winding and a secondary winding, and M is an integer not less than 3;
b) M bridge arms, wherein each bridge arm is coupled between two input terminals of the power converter to receive a DC input voltage, and each bridge arm comprises a high-side switch, a low-side switch, and a synchronous rectifier coupled in series;
c) wherein a first terminal of each of the primary windings is coupled to a common node between the high-side switch and the low-side switch in one of the M bridge arms, and a second terminal of each of the primary windings is coupled together; and
d) wherein one terminal of each of the secondary windings is coupled to a common node between the low-side switch and the synchronous rectifier in one of the M bridge arms, and the other terminal of each of the secondary windings is coupled to a first output terminal of the power converter.

2. The power converter of claim 1, wherein the first terminal is configured as a dotted terminal, and the second terminal is configured as a non-dotted terminal.

3. The power converter of claim 1, wherein a second output terminal of the power converter is grounded.

4. The power converter of claim 1, wherein each of the bridge arms is coupled to the primary winding in one of the M transformer units, and is coupled to the secondary winding in another one of the M transformer units.

5. The power converter of claim 4, wherein:
a) the first terminal of the primary winding of one in the M transformer units is coupled to the common node between the high-side switch and the low-side switch in one of the M bridge arms; and
b) the first terminal of the secondary winding in the one of the M transformer units is coupled to the common node between the low-side switch and the synchronous rectifier in another one of the M bridge arms.

6. The power converter of claim 4, wherein:
a) an i-th bridge arm comprises an i-th high-side switch, an i-th low-side switch, and an (i+1)-th synchronous rectifier coupled in series; the first terminal of the i-th primary winding is coupled to the common node between the i-th high-side switch and the i-th low-side switch; and
b) the first terminal of the (i+1)-th secondary winding is coupled to the common node between the (i+1)-th synchronous rectifier and the i-th low-side switch, wherein i is an integer that is less than M.

7. The power converter of claim 4, wherein:
a) an i-th bridge arm comprises an i-th high-side switch, an i-th low-side switch, and a first synchronous rectifier coupled in series; the first terminal of the i-th primary winding is coupled to the common node between the i-th high-side switch and the i-th low-side switch; and
b) the first terminal of the first secondary winding is coupled to the common node between the first synchronous rectifier and the i-th low-side switch, wherein i is equal to M.

8. The power converter of claim 6, wherein:
a) conduction times of the high-side switches are the same and sequentially have a phase difference of 360°/M; the i-th synchronous rectifier and the i-th high-side switch conduct alternately; and
b) in each bridge arm, the low-side power switch is turned on after both the high-side power switch and the synchronous rectifier are turned off.

9. The power converter of claim 1, wherein each of the bridge arms is coupled to the primary winding in one of the M transformer units, and is coupled to the secondary winding in the one of the M transformer units.

10. The power converter of claim 9, wherein:
a) the first terminal of the primary winding in one of the M transformer units is coupled to the common node between the high-side switch and the low-side switch in one of the M bridge arms; and
b) the second terminal of the secondary winding in the one of the M transformer units is coupled to the common node between the low-side switch and the synchronous rectifier in the one of the M bridge arms.

11. The power converter of claim 9, wherein:
a) the i-th bridge arm comprises an i-th high-side switch, an i-th low-side switch, and an i-th synchronous rectifier coupled in series; the first terminal of the i-th primary winding is coupled to the common node between the i-th high-side switch and the i-th low-side switch; and
b) the second terminal of the i-th secondary winding is coupled to the common node between the i-th low-side switch and the i-th synchronous rectifier, wherein i is an integer that is not greater than M.

12. The power converter of claim 11, wherein:
a) conduction times of the low-side switches are the same and sequentially have a phase difference of 360°/M; and
b) the i-th synchronous rectifier and the i-th low-side switch conduct alternately, and the i-th high-side switch and the i-th low-side switch conduct alternately.

13. The power converter of claim 1, wherein duty cycles of the high-side switches or the low-side switches in the M bridge arms are the same, and the maximum duty cycle is 1-1/M.

14. The power converter of claim 1, wherein:
a) a voltage conversion ratio of the power converter is a ratio of a duty cycle to the sum of 1 and turns ratio of the transformer unit, and the turns ratio of the transformer unit is a ratio of the number of turns of the primary winding to the number of turns of the secondary winding;
b) the M transformer units have the same turns ratio; and
c) the duty cycle is a ratio of a conduction time to a switching period of the high-side switch or the low-side switch.
